(19) United States
(12) Patent Application Publication
(10) Pub. No.: US 2018/0172926 A1
(43) Pub. Date: Jun. 21, 2018

(54) ILLUMINATION SLEEVE

(71) Applicant: Molex, LLC, Lisle, IL (US)

(72) Inventor: Malcolm H. Hodge, Chicago, IL (US)

(73) Assignee: Molex, LLC, Lisle, IL (US)

(21) Appl. No.: 15/757,068

(22) PCT Filed: Sep. 7, 2016
(86) PCT No.: PCT/US16/50535

§ 371 Date: Mar. 2, 2018

Related U.S. Application Data
(60) Provisional application No. 62/215,197, filed on Sep. 8, 2015.

(51) Int. Cl. G02B 6/42; F21V 33/00; F21V 8/00; G02B 6/02

(52) U.S. Cl. CPC G02B 6/42; F21V 33/0068; G02B 6/001; G02B 6/02; G02B 6/0008

(57) ABSTRACT

An illumination sleeve includes an elongated, hollow, flexible cylindrical body with the body formed of a resin and having an optical source end, an illumination end, and a central axis. An annular wall extends around the central axis and includes a plurality of optical cores therein. Each optical core is formed of a resin and includes a core axis generally parallel to the central axis. The annular wall further includes a plurality of cladding portions, with each cladding portion being formed of a resin. The plurality of optical cores have a core index of refraction and the plurality of cladding portions have a cladding index of refraction. The cladding index of refraction is less than the core index of refraction and each optical core is surrounded by and in contact with one of the cladding portions to form an optical waveguide.

### RELATED APPLICATIONS

This application claims priority to U.S. Provisional Application No. 62/215,197, filed Sep. 8, 2015, which is incorporated herein by reference in its entirety.

### TECHNICAL FIELD

This disclosure relates generally to illumination components and, more particularly, to a hollow sleeve having illumination capabilities and in which a portion of a tool may he positioned.

### BACKGROUND

Illumination is desirable in connection with a wide variety of instruments or tools such as those used in medical applications. In some instances, optical fibers are integrated into the instruments to provide illumination during a desired process. The integration of the illumination system may increase the cost, size, and complexity of the instruments.

Medical instruments that are reused may cause infections if the instruments are not adequately disinfected and/or sterilized. In addition to the cost, disinfection and/or sterilization of the instruments is often difficult and in some instances is not possible.

### SUMMARY

In one aspect, an illumination sleeve includes an elongated, hollow, flexible cylindrical body with the body formed of a resin and having an optical source end, an illumination end, and a central axis. An annular wall extends around the central axis and includes a plurality of optical cores therein. Each optical core is formed of a resin and includes a core axis generally parallel to the central axis. The annular wall further includes a plurality of cladding portions, with each cladding portion being formed of a resin. The plurality of optical cores have a core index of refraction and the plurality of cladding portions have a cladding index of refraction. The cladding index of refraction is less than the core index of refraction and each optical core is surrounded by and in contact with one of the cladding portions to form an optical waveguide.

In another aspect, an illumination system includes an illumination sleeve having an elongated, hollow, flexible cylindrical body. The body includes an illumination end, an optical source end spaced from the illumination end, and a central axis and the body is formed of a resin. An annular wall extends around the central axis and includes a plurality of optical cores therein. Each optical core has an output end adjacent the illumination end of the body and an input end adjacent the optical source end of the body. Each optical core is formed of a resin and includes a core axis generally parallel to the central axis. The annular wall further includes a plurality of cladding portions with each cladding portion being formed of a resin. The plurality of optical cores have a core index of refraction and the plurality of cladding portions have a cladding index of refraction, with the cladding index of refraction being less than the core index of refraction. Each optical core is surrounded by and in contact with one of the cladding portions to form an optical waveguide. A retention member secures the input ends of the optical cores in an array having a cross-sectional dimension less than a cross-sectional dimension of the annular wall adjacent the illumination end of the body. An illumination source is secured to and adjacent the input ends of the optical source to provide an illumination input to the illumination sleeve.

### BRIEF DESCRIPTION OF THE DRAWINGS

FIG. 1 illustrates a perspective view of an embodiment of an illumination sleeve;

FIG. 2 illustrates a side elevation view of the illumination sleeve of FIG. 1;

FIG. 3 illustrates the illumination sleeve of FIG. 1 but from a different perspective;

FIG. 4 illustrates an fragmented perspective view of the illumination end of the illumination sleeve of FIG. 1;

FIG. 5 illustrates a diagrammatic view of the illumination sleeve of FIG. 1 mounted on a tool with a light source;

FIG. 6 illustrates a fragmented side elevation view of a first embodiment of a structure for sealing the illumination sleeve of FIG. 1;

FIG. 7 illustrates a fragmented side elevation view of a second embodiment of a structure for sealing the illumination sleeve of FIG.

FIG. 8 illustrates a fragmented side elevation view of a third embodiment of a structure for sealing the illumination sleeve of FIG. 1;

FIG. 9 illustrates a fragmented side perspective view similar to FIG. 4 but of a second embodiment of an illumination sleeve; and

FIG. 10 illustrates a fragmented side perspective view similar to FIG. 4 but of a third embodiment of an illumination sleeve.

### DETAILED DESCRIPTION

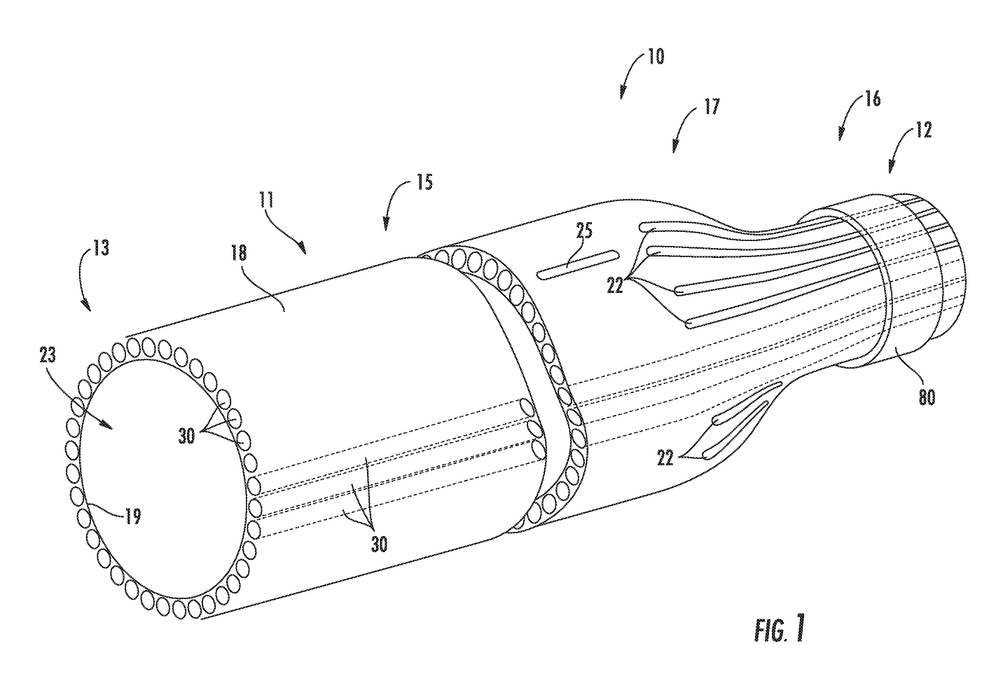

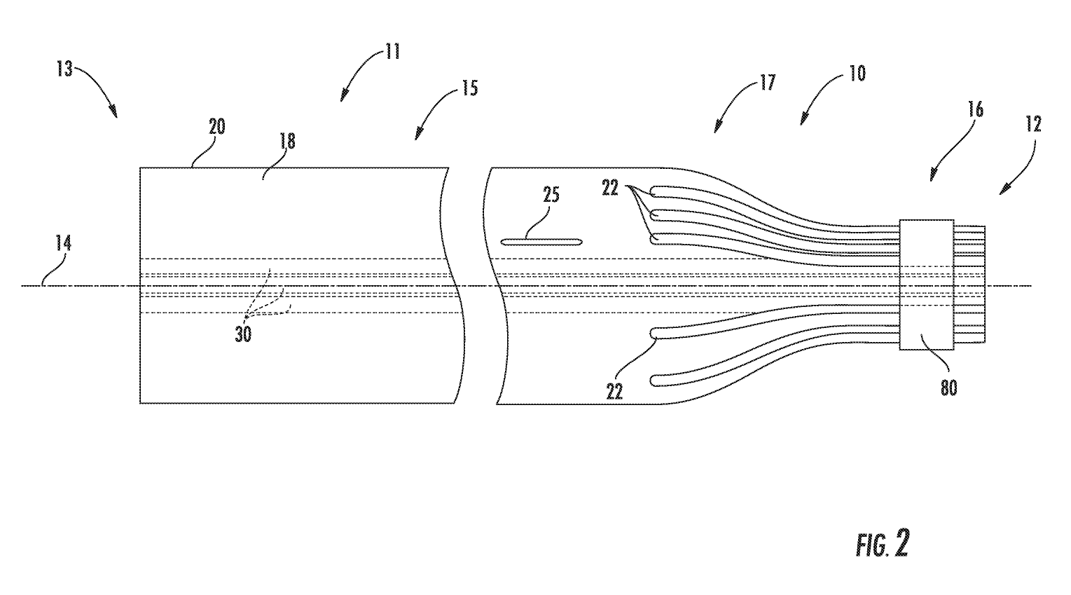

Referring to FIGS.1-4, an illumination sleeve is depicted generally at 10. The illumination sleeve includes an elongated, hollow, flexible cylindrical body 11 with an optical source end 12, an opposite illumination end 13, and a central axis 14 extending through the body between the ends. The body 11 includes a main body section 15 including the illumination end 13, a source section 16 including the optical source end 12, and a transition section 17 located between the main body section and the source section. The main body section 15 has a generally uniform, constant outer diameter. The optical source section 16 has a relatively small outer diameter that is substantially smaller than that of the main body section 15. The transition section 17 has an outer diameter that tapers or transitions from the relatively large outer diameter of the main body section 15 to the substantially smaller outer diameter of the source section 16.

Cylindrical body 11 has a relatively thin annular wall 18 that extends along its entire length. The annular wall 18 includes a generally continuous inner surface 19 and a generally continuous outer surface 20. The inner surface 19 defines a bore 23 having a generally uniform inner diameter along the body 11 from the illumination end 13 to the transition section 17. As described in more detail below, the optical source end 12 may be compacted or closed so that its inner diameter is essentially zero. The inner diameter of the transition section 17 may taper from that of the main body section 15 to that of the optical source end 12 along any desired shape (e.g., linear, arcuate, uniform, non-uniform).

A plurality of optical cores 30 are positioned within the annular wall 18 between the inner surface 19 and the outer surface 20. Each of the optical cores 30 has an input end 31 at the optical source end 12 of body 11 and an output end 32 at the illumination end 13 of the body with a central or core axis 33 extending through the optical core between the ends. The core axis 33 is generally parallel to the central axis 14 of cylindrical body 11, at least along the main body section 15. Although the optical cores 30 are depicted as having a generally circular cross-section (and thus are generally cylindrical), the optical cores may have any desired cross-section.

The optical cores 30 may be formed of a resin such as polymethyl acrylate, polystyrene, polycarbonate, or any other material having the desired optical and mechanical characteristics. The annular wall 18 may also be formed of a resin similar or identical to the resin from which the optical cores 30 are formed. The optical cores 30 have an index of refraction referred to herein as a first or core index of refraction. The annular wall 18 has a second or cladding index of refraction that is less than the core index of refraction. In some instances, the material used to form the annular wall 18 may be fluorinated to reduce its index of refraction. In other instances, the optical cores 30 may be doped to raise their index of refraction.

The optical cores 30 may be positioned about the annular wall 18 in a closely spaced, but non-touching relationship. The optical cores 30 may be any distance apart provided that the annular wall 18 provides a sufficient amount of material between the cores and along the inner surface 19 and outer surface 20 to permit light to efficiently pass through the optical cores. More specifically, since the annular wall 18 surrounds and is in contact with each of the optical cores 30, a portion, depicted by dotted lines 21 of the annular wall 18 in FIG. 4, acts as a cladding portion for each optical core so that each combination or pair of optical core and cladding portion form an optical waveguide. As depicted, the cladding portions 21 are interconnected to form the annular wall 18 with the plurality of optical cores 30 embedded within the annular wall to form a plurality of optical waveguides positioned in a circular array

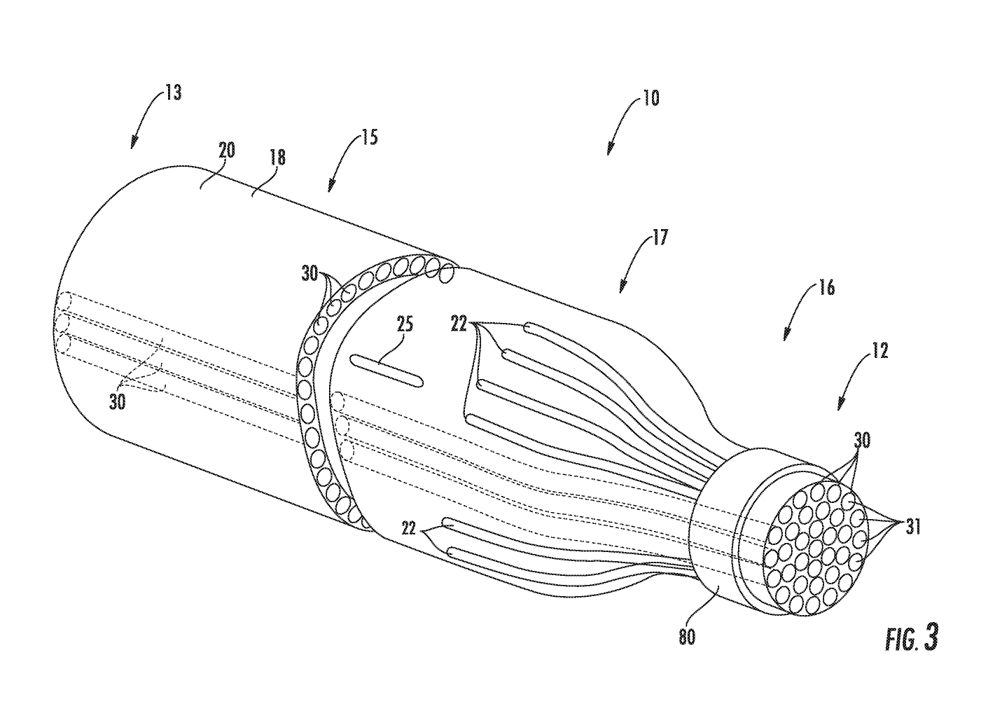

As stated above, the optical source end 12 and source section 16 have a substantially smaller outer diameter than the outer diameter of illumination end 13 and main body section 15. During the process of fabricating the illumination sleeve 10, the annular wall 18 together with the optical cores 30 therein along the source section 16 are folded, rolled, wrapped or otherwise positioned to eliminate or reduce the inner diameter so that the input ends 31 of the optical cores 30 are positioned in a closely packed array minimizing the space between the cores (FIG. 3). The transition section 17 may take any desired shape that facilitates the transition from the larger outer diameter of main body section 15 to the smaller outer diameter of the source section 16. Lines 22 generally reflect folds or other structure used to reduce the diameter of the main body section 15. It should be noted that the source section 16 and the transition section 17 may not have a smooth outer surface due to the fold in, rolling, wrapping or other reshaping of the source section and the transition section.

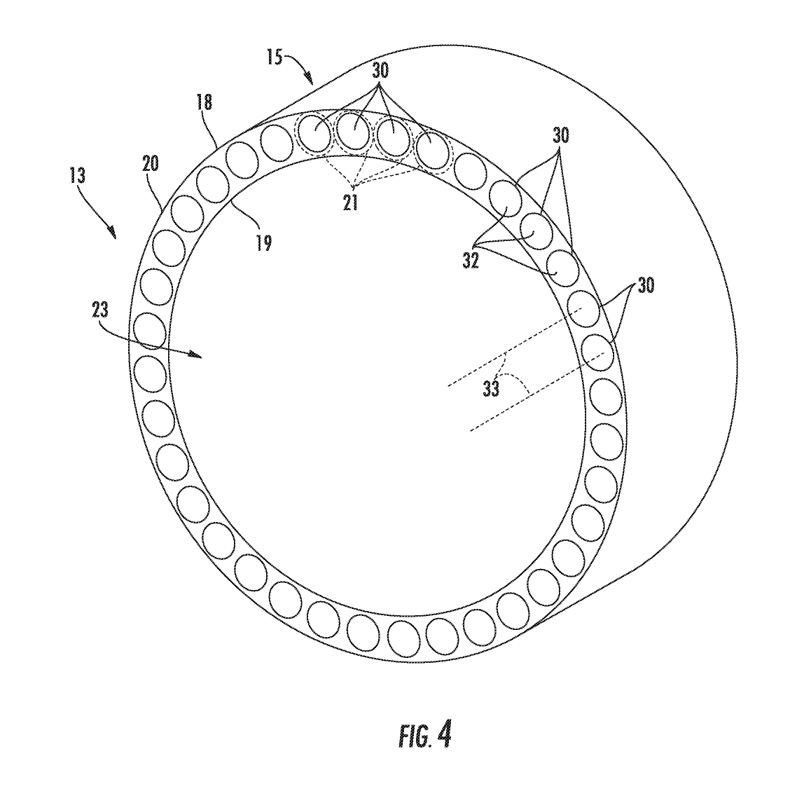

An opening 25 such as an elongated slit may be provided in body 11 and extend between the outer surface 20 and the inner surface 19 to permit an elongated member such as an elongated tube 101 of a tool 100 (FIG. 5) to be inserted into the inner bore 23 of the body. In one example, the tool 100 may be an endoscope and the opening 25 configured as a slit to receive the insertion tube of the endoscope therein.

By configuring the opening as an elongated slit that extends generally parallel to the central axis 14 of body 11 and thus generally parallel to the axes 33 of the optical cores 30, the number of optical cores disrupted by forming the opening may be minimized. In other words, referring to FIG. 4, in some fabrication processes, opening 25 may extend between optical cores 30 and leave a sufficient amount of the cladding portion 21 intact so as to not affect the optical waveguides adjacent the opening. In other fabrication processes, a cutting tool such as a knife may render one or more of the waveguides adjacent the opening 25 inoperative. In view of the number of waveguides present in the illumination sleeve 10, a relatively small number of inoperative optical waveguides may not significantly affect the performance of the illumination sleeve. In other examples, the opening may be configured in other manners.

Referring to FIG. 5, when using the illumination sleeve 10, the elongated tube 101 of tool 100 may be inserted into opening 25 until the end of the tube is even with or extends from the illumination end 13. An illumination source 102 may be positioned adjacent the input ends 31 of the optical cores 30 and at an appropriate angle to the optical cores so that light enters each optical core and passes through the body 11 from the optical source end 12 of the body to the illumination end 13 of the body where it exits from the output ends 32 of the optical cores to provide illumination to a desired area adjacent the illumination end.

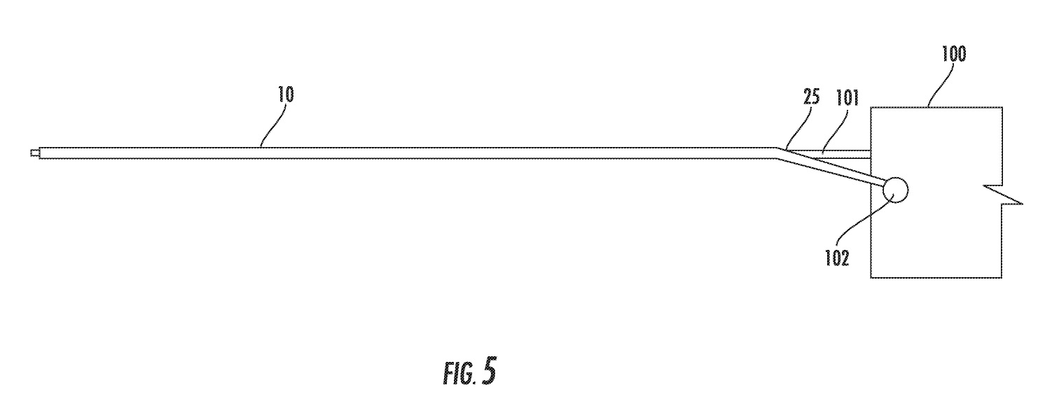

If desired, the illumination end 13 of elongated body 11 may be sealed by applying a transparent film (FIG. 6) that functions as an end closure 35 that extends across and seals the illumination end. The transparent film may be secured to the illumination end 13 by an adhesive such as an ultraviolet cured epoxy, by welding, or any other desired process. By utilizing an end closure 35, the illumination sleeve 10 may operate to seal the elongated tube 101 that is positioned within the inner bore 23 of the illumination sleeve. In doing so, the elongated tube 101 may only extend to the end of the end closure 35 rather than past the illumination end 13. Light exiting from the output ends 32 of the optical cores 30 will generally not be affected by the addition of the end closure 35 as depicted by the expanding cones 110 of light as depicted in FIG. 6.

In an alternate embodiment depicted in FIG. 7, a smaller transparent end closure 40 may be secured to the illumination end 13 of elongated body 11 to create a tapered end 41. The end closure 40 may be similar to the end closure 35 described above but has a smaller diameter. During assembly, the illumination end 13 of body 11 may be deformed slightly so that tapers and may be affixed to the smaller diameter of end closure 40.

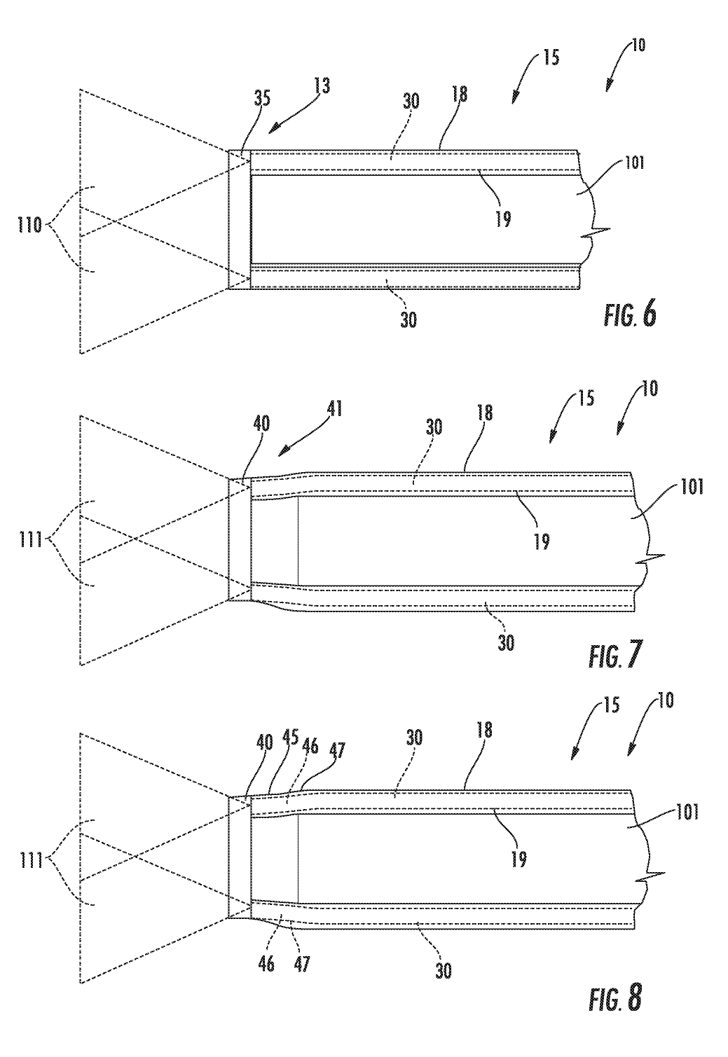

In another embodiment depicted in FIG. 8, a tapered sleeve end 45 may include a plurality of optical cores 46 surrounded by cladding portions 47 with each optical core aligned with one of the optical cores 30 of the elongated body 11 with the sleeve end closed by an end closure 40. The tapered sleeve end 45 may be secured to the illumination end 13 of the elongated body 11 in any desired manner such as by using an adhesive or welding.

By utilizing the tapered end 40, light exiting from the output ends 32 of the optical cores 30 is redirected so that the expanding cones 111 of light overlap to a greater extent as depicted in FIG. 7 as compared to expanding cones 110 in FIG. 6. Referring to the tapered sleeve end 45, light exiting the output ends 32 of the optical cores 30 is directed into the optical cores 46 and the light redirected so that the expanding cones 111 of light overlap in a manner similar to that of FIG. 7.

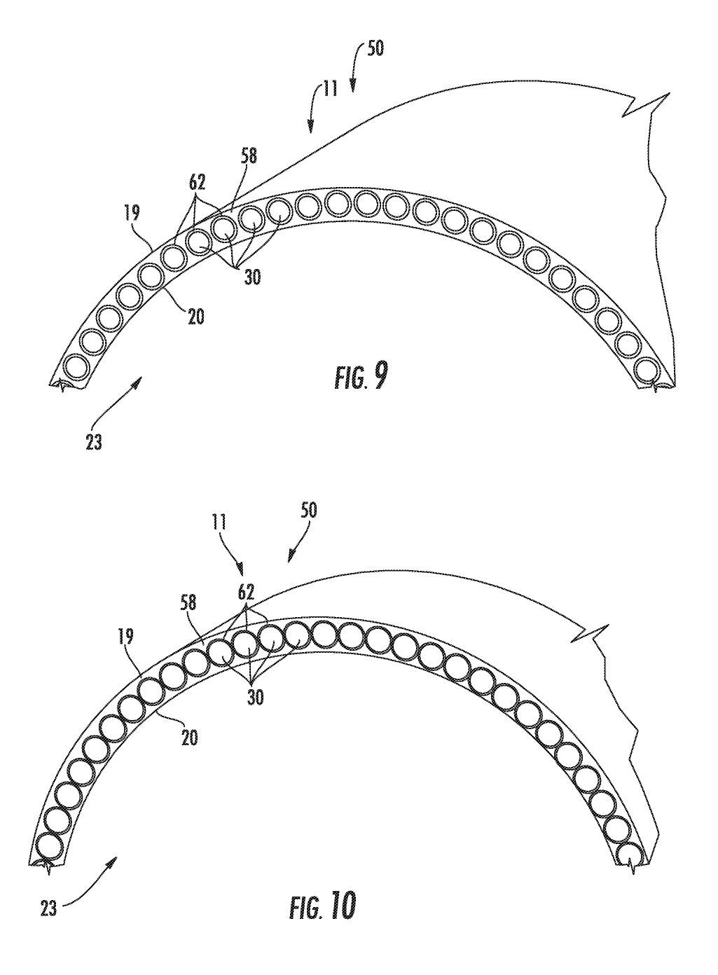

Referring to FIGS. 9-10, alternate embodiments of an illumination sleeve 50 are depicted. Like components are identified by like reference numbers and the descriptions thereof are not repeated. Illumination sleeve 50 has a cylindrical body 11 with an annular wall 58. A plurality of optical cores 30 are positioned within the annular wall 58 between the inner surface 19 and the outer surface 20. Each of the optical cores 30 is surrounded by and in contact with a cladding portion to form a plurality of optical waveguides. Each cladding portion is a hollow, generally cylindrical cladding member 62 that includes a cladding axis which is co-linear with the core axis 33 of the optical core 30 that it surrounds. Each cladding member 62 has a cladding index of refraction that is less than the core index of refraction of its associated optical core 30. As such, each combination of optical core 30 and cladding portion 61 resemble a length of plastic optical fiber. In FIG. 9, the cladding members 62 are spaced apart within the annular wall 58 while in the alternate embodiment depicted in FIG. 10, adjacent cladding members are in contact with each other.

In one example, the illumination sleeve 10, 50 may be fabricated by forming a preform having a cross-section identical to the desired cross-section of the annular wall 18, 58. The elongated body 11 may be formed by drawing the preform in a known manner and then cutting the drawn component to the desired length. Ends of the cut length may be designated as the optical source end 12 and the illumination end 13.

A retention member such as a collar 80 (FIG. 1), an adhesive (not shown), or any other desired structure or component may be used to secure the annular wall 18 (including the optical cores 30 therein) at the optical source end 12 in a closely packed array as depicted in FIG. 3 to minimize the space between the cores. In one embodiment, the retention member may secure the optical cores 30 in an array having a circular cross-section. In other embodiments, the optical cores may be secured in arrays having other configurations.

An opening 25 may be formed in elongated body 11 to permit the insertion of an elongated member such as a portion of a tool. As described above, the opening may be formed as an elongated slit that extends generally parallel to the central axis 14 of the elongated body 11 and the core axes 33 to minimize the number of optical cores 30 damaged or disrupted while forming the opening. If desired, an end closure 35, 40 or a tapered sleeve end 45 may be mounted or attached to the elongated body 11 to seal the illumination end 13 as described above.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. An illumination sleeve comprising:
an elongated, hollow, flexible cylindrical body, the body being formed of a resin and having an optical source end, an illumination end, and a central axis, an annular wall extends around the central axis;
the annular wall including a plurality of optical cores therein, each optical core being formed of a resin and including a core axis generally parallel to the central axis, the plurality of optical cores having a core index of refraction; and
the annular wall further including a plurality of cladding portions, each cladding portion being formed of a resin, the plurality of cladding portions having a cladding index of refraction, the cladding index of refraction being less than the core index of refraction, each optical core being surrounded by and in contact with one of the cladding portions to form an optical waveguide.

2. The illumination sleeve of claim 1, wherein each optical core is generally cylindrical.

3. The illumination sleeve of claim 2, wherein each cladding portion is a hollow, generally cylindrical cladding member surrounding and in contact with one of the optical cores and includes a cladding axis, each cladding axis being collinear with one of the core axes.

4. The illumination sleeve of claim 2, wherein the cladding portions form generally continuous inner and outer surfaces of the annular wall.

5. The illumination sleeve of claim 2, wherein the annular wall is formed of a cladding member formed of a resin, the optical cores having a first having a core index of refraction and the cladding member having a cladding index of refraction, the core index of refraction being higher than the cladding index of refraction.

6. The illumination sleeve of claim 1, wherein the cladding portions are interconnected.

7. The illumination sleeve of claim 1, wherein each cladding portion is a hollow, generally cylindrical cladding member surrounding and in contact with one of the optical cores and includes a cladding axis, each cladding axis being collinear with one of the core axes.

8. The illumination sleeve of 7, wherein the plurality of cladding members are interconnected by an interconnection web, the interconnection web being formed of a resin.

9. The illumination sleeve of claim 8, wherein the interconnection web is formed of a material different from the cladding material.

10. The illumination sleeve of claim 1 herein the body includes an illumination end and an optical source end spaced from the illumination end.

11. The illumination sleeve of claim 10, further including a end closure secured to and closing the cylindrical body at the illumination end.

12. The illumination sleeve of claim 11 wherein the end closure has a diameter generally equal to a diameter of the body.

13. The illumination sleeve of claim 11, wherein the end closure has a diameter less than a diameter of the body.

14. The illumination sleeve of claim 1, further including an elongated opening in the annular wall, an axis of the elongated opening being generally parallel to the central axis.

15. The illumination sleeve of claim 14, wherein the elongated opening is a slit in the annular wall, the slit being generally parallel to the central axis.

16. An illumination system comprising:
an illumination sleeve including an elongated, hollow, flexible cylindrical body, the body including an illumination end and an optical source end spaced from the illumination end, the body being formed of a resin and including a central axis and an annular wall extending around the central axis, the annular wall including a plurality of optical cores therein, each optical core having an output end adjacent the illumination end of the body and an input end adjacent the optical source end of the body, each optical core being formed of a resin and including a core axis generally parallel to the central axis, the plurality of optical cores having a core index of refraction, and the annular wall further including a plurality of cladding portions, each cladding portion being formed of a resin, the plurality of cladding portions having a cladding index of refraction, the cladding index of refraction being less than the core index of refraction, each optical core being surrounded by and in contact with one of the cladding portions to form an optical waveguide;
a retention member securing the input ends of the optical cores in an array having a cross-sectional dimension less than a cross-sectional dimension of the annular wall adjacent the illumination end of the body; and
an illumination source secured to and adjacent the input ends of the optical source to provide an illumination input to the illumination sleeve.

17. The illumination system of claim 16, wherein the collar is configured to position the input ends of the optical cores in a generally circular array, and the diameter of the circular array is less than a diameter of the annular wall adjacent the illumination end of the body.

18. The illumination system of claim 17, wherein the diameter of the circular array is substantially less than a diameter of the annular wall adjacent the illumination end of the body.
